(19) United States
(12) Patent Application Publication
(10) Pub. No.: US 2020/0134547 A1
(43) Pub. Date: Apr. 30, 2020

(54) METHOD AND APPARATUS FOR PROCESSING INFORMATION

(71) Applicants: Beijing Jingdong Shangke Information Technology Co., Ltd., Beijing (CN); Beijing Jingdong Century Trading Co., Ltd., Beijing (CN)

(72) Inventors: Bo Zhao, Beijing (CN); Wenming Zhe, Beijing (CN); Yukai Zhao, Beijing (CN)

(21) Appl. No.: 16/627,912

(22) PCT Filed: Apr. 11, 2018
(86) PCT No.: PCT/CN2018/082685

§ 371 Date: Dec. 31, 2019

(30) Foreign Application Priority Data
Aug. 4, 2017 (CN) 201710661613.3

(51) Int. Cl. G06Q 10/08; H04L 9/32; G06Q 50/28

(52) U.S. Cl. CPC G06Q 10/087; G06Q 50/28; H04L 9/3236

(57) ABSTRACT

A method and apparatus for processing information are provided. The method may include: generating a packing code based on information of a target stock keeping unit (SKU), the information of the target SKU including a code of the target SKU; storing the information of the target SKU and the packing code in association; finding a packing code stored in association with the code of the target SKU, and determining the number of found packing codes; and executing, in response to the number being greater than or equal to two, one of the following processes: retaining a target packing code, and deleting other packing codes except for the target packing code in the found packing codes; or marking the target packing code by a first marking approach, and marking the other packing codes except for the target packing code in the found packing codes by a second marking approach.

### CROSS-REFERENCE TO RELATED APPLICATIONS

The present disclosure claims priority to Chinese Patent Application No. 201710661613.3, filed on Aug. 4, 2017, and entitled “Method and Apparatus for Processing Information” by the Applicant “Beijing Jingdong Shangke Information Technology Co., Ltd.” and “Beijing Jingdong Century Trading Co., Ltd.” The contents of which are hereby incorporated by reference in their entirety.

### TECHNICAL FIELD

The present disclosure relates to the field of computer technology, specifically to the field of Internet technology, and more specifically to a method and apparatus for processing information.

### BACKGROUND

When massive SKUs (Stock Keeping Units, a basic unit for measuring in and out of a stock) are put in storage, packing is required. Both information of a SKU and packing information of the SKU are required to be entered into the system. The conventional management approach is: an on-site staff collects information, and then summarizes and codes the information and then enters the same into the system, thereby having the problems of information redundancy and low automation degree of information processing.

### SUMMARY

The purpose of the embodiment of the application is to provide an improved method for processing information and a device to solve the technical problems mentioned in the above background part.

According to a first aspect, some embodiments of the present disclosure provide a method for processing information, the method includes: generating a packing code based on information of a target stock keeping unit (SKU), a SKU being for measuring in and out of a stock, the information of the target SKU comprising a code of the target SKU, the packing code being used for identifying size information of a box into which the target SKU is to be packed; storing the information of the target SKU and the packing code in association; finding a packing code stored in association with the code of the target SKU, and determining a number of found packing codes; and executing, in response to the number being greater than or equal to two, one of following processes: retaining a target packing code, and deleting other packing codes except for the target packing code in the found packing codes; or marking the target packing code by a first marking approach, and marking the other packing codes except for the target packing code in the found packing codes by a second marking approach.

In some embodiments, where after the executing one of following processed, the method further includes: sending the information of the target SKU and the target packing code to a target device, wherein the target device is configured to receive and store the information of the target SKU and the target packing code in association.

In some embodiments, where after the executing one of following processes, the method further includes: determining, in response to receiving a first request for finding information of a SKU corresponding to a code of the SKU, whether the code of the SKU included in the first request is stored; and finding and outputting, in response to determining the code of the SKU included in the first request being stored, information of the SKU stored in association with a first packing code corresponding to the code of the SKU included in the first request, wherein the first packing code is the retained packing code or the packing code marked by the first marking approach.

In some embodiments, where after the executing one of following processes, the method further includes: determining, in response to receiving a second request for finding information of a SKU stored in association with a packing code, whether the packing code included in the second request is a first packing code, wherein the first packing code is the retained packing code or the packing code marked by the first marking approach; and finding and outputting, in response to determining the packing code included in the second request being the first packing code, information of the SKU stored in association with the packing code included in the second request.

In some embodiments, where the target packing code is a first found packing code or a randomly selected packing code.

In some embodiments, where the generating a packing code based on information of a target stock keeping unit (SKU), a SKU being for measuring in and out of a stock, includes: processing the information of the target SKU using a message digest algorithm version 5 or a secure hash algorithm, to generate the packing code.

In some embodiments, the information of the target SKU furhter includes a number of SKUs containable in the box into which the target SKU is to be packed; and where the generating a packing code based on information of a target stock keeping unit (SKU), a SKU being for measuring in and out of a stock, includes: generating a measurement unit code based on the code of the target SKU, and the number of SKUs containable in the box into which the target SKU is to be packed, wherein the measurement unit code is used for identifying a packing approach of the target SKU; storing the measurement unit code, in response to determining there being no other measurement unit code identical to the measurement unit code; generating the packing code based on the measurement unit code and the size information of the box into which the target SKU is to be packed; and storing the packing code, in response to determining there being no other packing code identical to the packing code.

According to second aspect, some embodiments of the present disclosure provide an apparatus for processing information, the apparatus includes: a generating unit configured to generate a packing code based on information of a target stock keeping unit (SKU), a SKU being for measuring in and out of a stock, the information of the target SKU comprising a code of the target SKU, the packing code being used for identifying size information of a box into which the target SKU is to be packed; a storing unit configured to store the information of the target SKU and the packing code in association; a first determining unit configured to find a packing code stored in association with the code of the target SKU, and determine a number of found packing codes; and an executing unit configured to execute, in response to determining the number being greater than or equal to two, one of following processes: retaining a target packing code, and deleting other packing codes except for the target packing code in the found packing codes; or marking the target packing code by a first marking approach, and marking the other packing codes except for the target packing code in the found packing codes by a second marking approach.

In some embodiments, the apparatus further includes: a sending unit configured to send the information of the target SKU and the target packing code to a target device, wherein the target device is configured to receive and store the information of the target SKU and the target packing code in association.

In some embodiments, the apparatus further includes: a second determining unit configured to determine, in response to receiving a first request for finding information of a SKU corresponding to a code of the SKU, whether the code of the SKU included in the first request is stored; and a first outputting unit configured to find and output, in response to determining the code of the SKU included in the first request being stored, information of the SKU stored in association with a first packing code corresponding to the code of the SKU included in the first request, wherein the first packing code is the retained packing code or the packing code marked by the first marking approach.

In some embodiments, the apparatus further includes: a third determining unit configured to determine, in response to receiving a second request for finding information of a SKU stored in association with a packing code, whether the packing code included in the second request is a first packing code, wherein the first packing code is the retained packing code or the packing code marked by the first marking approach; and a second outputting unit configured to find and output, in response to determining the packing code included in the second request being the target packing code, information of the SKU stored in association with the packing code included in the second request.

In some embodiments, the information of the target SKU further comprises a number of SKUs containable in the box into which the target SKU is to be packed; and where the generating unit further includes: a first generating module configured to generate a measurement unit code based on the code of the target SKU, and the number of SKUs containable in the box into which the target SKU is to be packed, wherein the measurement unit code is used for identifying a packing approach of the target SKU; a first storing module configured to store the measurement unit code, in response to determining there being no other measurement unit code identical to the measurement unit code; a second generating module configured to generate the packing code based on the measurement unit code and size information of the box into which the target SKU is packed; and a second storing module configured to store the packing code, in response to determining there being no other packing code identical to the packing code.

According to a third aspect, some embodiments of the present disclosure provide an information processing device, including: one or more processors; and a storage apparatus configured to store one or more programs, where the one or more programs, when executed by the one or more processors, cause the one or more processors to implement the method according to any one of the embodiments of the above method for processing information.

According to a fourth aspect, some embodiments of the present disclosure provide a computer readable storage medium, storing a computer program thereon, wherein the program, when executed by a processor, implements the method according to any one of the embodiments of the above method for processing information.

The method and apparatus for processing information provided by embodiments of the present disclosure generate a packing code based on information of a target stock keeping unit (SKU), the information of the target SKU including a code of the target SKU, the packing code being used for identifying size information of a box into which the target SKU is to be packed; store the information of the target SKU and the packing code in association; find a packing code stored in association with the code of the target SKU, and determine the number of found packing codes; and execute, in response to the number being greater than or equal to two, one of the following processes: retaining a target packing code, and deleting other packing codes except for the target packing code in the found packing codes; or marking the target packing code by a first marking approach, and marking the other packing codes except for the target packing code in the found packing codes by a second marking approach, thereby effectively improving the automation degree of information processing, and reducing the information redundancy.

### BRIEF DESCRIPTION OF THE DRAWINGS

After reading detailed description of non-limiting embodiments with reference to the following accompanying drawings, other features, objectives and advantages of the present disclosure will become more apparent.

FIG. 1 is a diagram of an example system architecture in which embodiments of the present disclosure may be implemented;

FIG. 2 is a flowchart of a method for processing information according to an embodiment of the present disclosure;

FIG. 3A is a schematic diagram of an application scenario of the method for processing information according to some embodiments of the present disclosure;

FIG. 3B is a schematic diagram of another application scenario of the method for processing information according to some embodiments of the present disclosure;

FIG. 3C is a schematic diagram of still another application scenario of the method for processing information according to some embodiments of the present disclosure;

FIG. 4 is a flowchart of the method for processing information according to another embodiment of the present disclosure;

FIG. 5 is a schematic structural diagram of an apparatus for processing information according to an embodiment of the present disclosure; and

FIG. 6 is a schematic structural diagram of a computer system adapted to implement a terminal device of embodiments of the present disclosure.

### DETAILED DESCRIPTION OF EMBODIMENTS

Embodiments of present disclosure will be described below in detail with reference to the accompanying drawings. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the some embodiments in the present disclosure and some features in the disclosure may be combined with each other on a non-conflict basis. Features of the present disclosure will be described below in detail with reference to the accompanying drawings and in combination with embodiments

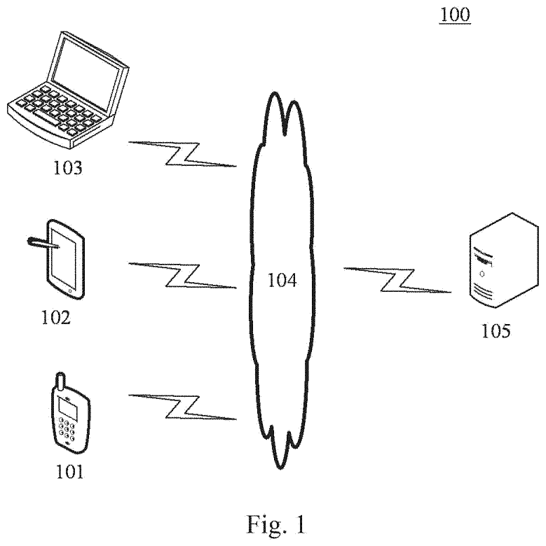

FIG. 1 shows an example system architecture 100 in which a method for processing information or an apparatus for processing information of embodiments of the present disclosure may be implemented.

As shown in FIG. 1, the system architecture 100 may include terminal devices 101, 102, and 103, a network 104, and a server 105. The network 104 serves as a medium providing a communication link between the terminal devices 101, 102, and 103, and the server 105. The network 104 may include various types of connections, such as wired or wireless communication links, or optical cables.

A user may interact with the server 105 using the terminal devices 101, 102, and 103 via the network 104, e.g., to receive or send a message. The terminal devices 101, 102, and 103 may be provided with various communication client applications, such as information processing application, a shopping application, a search application, an instant messaging tool, an email client, and social platform software.

The terminal devices 101, 102 and 103 may be various electronic devices having display screens and supporting information processing, including but not limited to smart phones, tablet computers, laptop portable computers, desktop computers, devices specially made based on the method for processing information, and the like.

The server 105 may be a server providing various services, such as a data processing server providing support for information processed on the terminal devices 101, 102, and 103. The data processing server may correspondingly process a received request for, e.g., data query, addition, or deletion, and return the processing result (e.g., data meeting a query condition) to the terminal devices.

It should be noted that the method for processing information provided by the embodiments of the present disclosure is generally executed by the terminal devices 101, 102, and 103. Accordingly, the apparatus for processing information is generally provided in the terminal devices 101, 102, and 103.

It should be understood that the numbers of terminal devices, networks, and servers in FIG. 1 are merely illustrative. Any number of terminal devices, networks, and servers may be provided based on actual requirements. When an electronic device on which the method for processing information runs does not need data transmission with the server, the system architecture may not include the server.

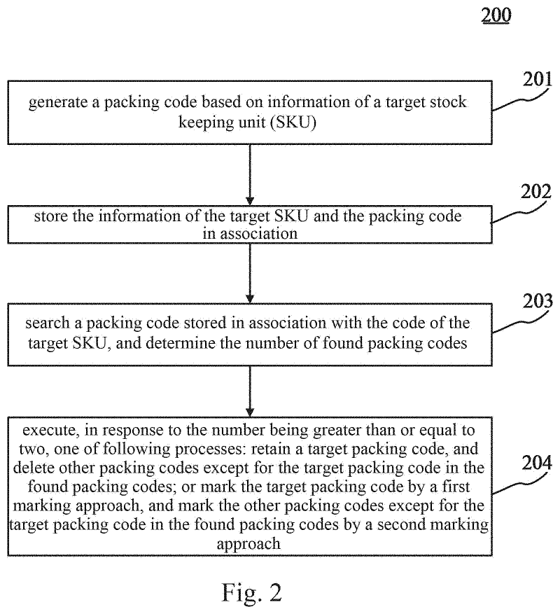

Further referring to FIG. 2, a process 200 of a method for processing information according to an embodiment of the present disclosure is shown. The method for processing information includes the following steps:

Step 201: generating a packing code based on information of a target stock keeping unit (SKU), a SKU being used for measuring in and out of a stock.

In the present embodiment, an electronic device (e.g., the terminal shown in FIG. 1), the method for processing information runs thereon, may generate the packing code of the SKU using a preset algorithm based on the information of the SKU.

The information of the target SKU may be inputted by a user, or transmitted by other devices, or pre-stored in the electronic device. The information of the target SKU includes a code of the target SKU, and the packing code is used for identifying size information of a box into which the target SKU is to be packed. The preset algorithm is an algorithm that is preset. By using the preset algorithm, generating same packing codes based on information of the same SKUs and generating different packing codes based on information of different SKUs or different information items of a same SKU (for example: the code of the SKU, and unit of the SKU) may be realized. Different SKUs are different in at least one of attribute, such as brand, model, configuration, grade, color, packing capacity, unit, use, price, or origin. The codes of the SKUs are used for identifying the above different SKUs, and the codes of SKUs corresponding to the different SKUs are different. The information of a SKU may include, but is not limited to, the following information: the code of the SKU, name, measurement unit, packing unit (for example: bag, box, or drum), nested unit information of packing at each level (for example: bag, drum, and box), mass, the number of SKUs containable in a box into which the SKU is to be packed, and size information of the box into which the SKU is packed. The information of a SKU may be adjusted based on actual requirements. The number of SKUs containable in a box into which the SKU is to be packed refers to, before packing the SKU, an estimated number of SKUs containable in the box. As an example, the nested unit information of the above packing at each level may be “4*(bag*6 bottles)/box.” “4*(bags*6 bottles)/box” is used for representing that there are 4 bags in a current box, and there are 6 bottles of SKUs in each bag.

In some alternative implementations of the present embodiment, the above preset algorithm may be at least one of the following: a data encryption standard algorithm, a message digest algorithm version 5, or a secure hash algorithm. For example, assuming that a batch of wine newly arrives at a warehouse, the wine needs to be boxed. First, 6 bottles of the wine may be boxed, and information of the wine is inputted and a packing code “111111” is generated based on the message digest algorithm version 5, while when 4 bottles of wine are boxed, even though the size of the box into which the 4 bottles of wine are to be packed is the same as the size of the box into which the 6 bottles of wine are packed, the generated packing code will not be “111111.”

It should be noted that the algorithm is a well-known technology widely researched and applied at present. The description thereof will not be repeated here.

In some alternative implementations of the present embodiment, the packing code may be generated by nested packing based on the information of the SKU. As an example, assuming that a batch of wine newly arrives at a warehouse, 6 cans of the wine need to be packed into a bag first, and then 4 bags (6 cans of wine in each bag) of the wine need to packed into a box. In this case, a code of each bag of wine may be first generated based on the information of the wine. For example, a code of the wine (for example: 1), a unit of the wine (for example: can), a volume (for example: 330 mL), a number of SKUs (for example: 6), and a size of a bag (for example: 15 cm*6 cm*20 cm) are inputted to generate the code of each bag of the wine (for example: 111). Then, the packing code is generated based on information of each bag of the wine. For example, a packing code (for example: 123) of the wine after nested packing is generated based on the code of each bag of the wine (for example: 111), the number of SKUs (in this case, each bag of the wine may be regarded as a SKU, and then the number of SKUs is 4), the code of the SKU (for example: 10), and the size of the box (for example: 30 cm*12 cm*40 cm). It will be appreciated that the above box packing 4 bags of the wine with 6 cans of the wine in each bag may still be regarded as a SKU, for further packing and generating a new packing code.

Step 202: storing the information of the target SKU and the packing code in association.

In the present embodiment, the electronic device (e.g., the terminal device shown in FIG. 1) stores, based on the packing code obtained in step 201, the information of the SKU and the packing code generated based on the SKU information in association.

In some alternative implementations of the present embodiment, the storing in association may be carried out in the form of a data type, such as an array or a dictionary, and various nested data types, to facilitate establishing a relationship between the information of a same SKU, and between the information of the same SKU and the packing code, and storing data with the established relationship into a persistent database.

Step 203: finding packing codes stored in association with the code of the target SKU, and determining the number of found packing codes.

In the present embodiment, the electronic device on which the method for processing information runs may find out, based on the code of the SKU, all packing codes stored in association with the code of the SKU, and then determine the number of found packing codes stored in association with the code of the SKU.

Step 204: executing, in response to the number being greater than or equal to two, one of following processes: retaining a target packing code, and deleting other packing codes except for the target packing code in the found packing codes; or marking the target packing code by a first marking approach, and marking the other packing codes except for the target packing code in the found packing codes by a second marking approach.

In the present embodiment, if the number of found packing codes in step 203 is not unique, then the target packing code is selected from the found packing codes, a storing operation or a marking operation on the target packing code is executed, and a deleting operation on other found packing codes is correspondingly executed or the other found packing codes are marked by a marking approach different from a marking approach of the target packing code, to select the target packing code or distinguish the target packing code from the other found packing codes. The target packing code is a packing code in the found packing codes, and alternatively, the above target packing code may be determined by random selection. The above first marking approach and second marking approach are used for marking the target packing code and the other found packing codes differently.

In some alternative implementations of the present embodiment, the target packing code may include: a first found packing code or a randomly selected packing code.

In some alternative implementations of the present embodiment, the generating a packing code based on information of a target stock keeping unit (SKU), a SKU being for measuring in and out of a stock, may specifically include: processing the information of the target SKU using the message digest algorithm version 5 or the secure hash algorithm, to generate the packing code.

In some alternative implementations of the present embodiment, the information of the target SKU further includes the number of SKUs containable in the box into which the target SKU is to be packed; and the generating a packing code based on information of a target stock keeping unit (SKU), a SKU being for measuring in and out of a stock, includes: generating a measurement unit code based on the code of the target SKU, and the number of SKUs containable in the box into which the target SKU is to be packed, where the measurement unit code is used for identifying a packing approach of the target SKU; storing the measurement unit code, in response to determining there being no other measurement unit code identical to the measurement unit code; generating the packing code based on the measurement unit code and size information of the box into which the target SKU is packed; and storing the packing code, in response to determining there being no other packing code identical to the packing code.

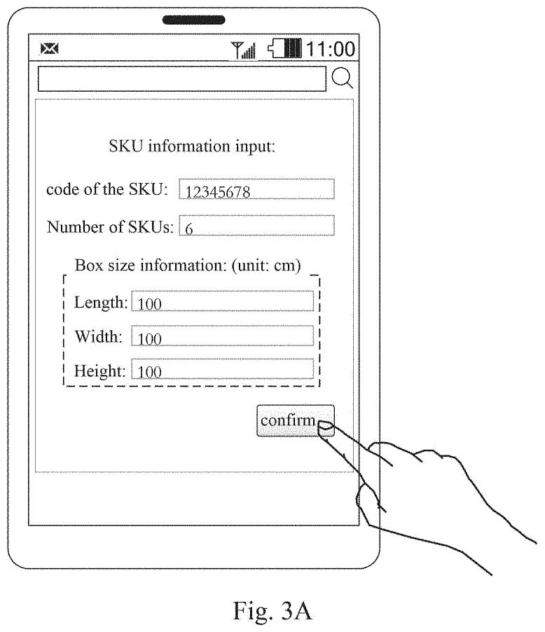

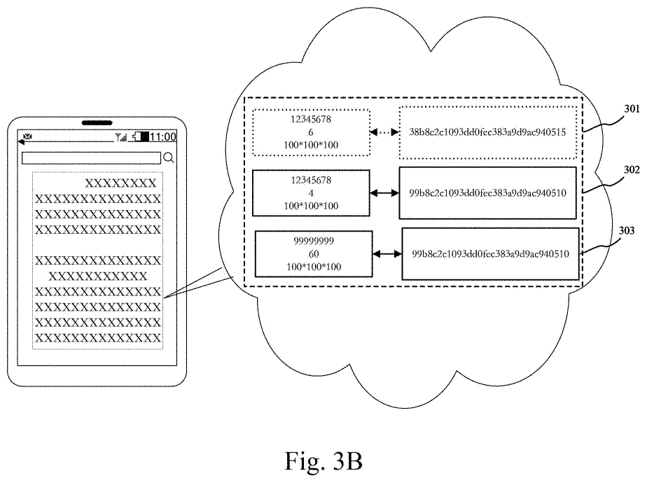

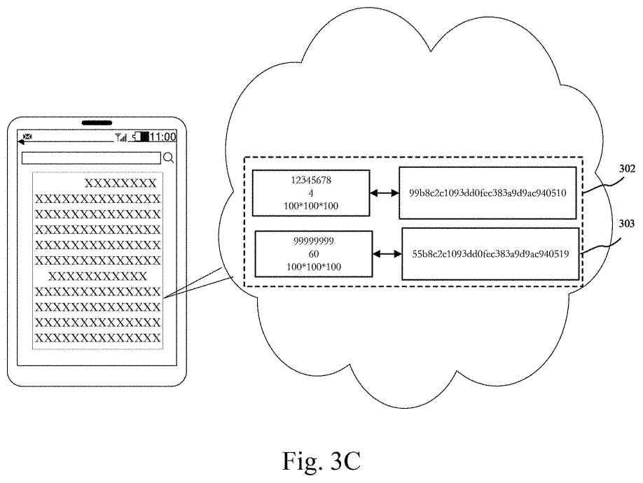

Further referring to FIG. 3A, FIG. 3A is a schematic diagram of an application scenario of the method for processing information according to the present embodiment. In the application scenario of FIG. 3A, a user first inputs information of a SKU: a code of the SKU: 12345678, the number of SKUs (i.e.: the number of SKUs containable in a box into which the SKU is to be packed): 6, box length: 100 cm, box width: 100 cm, and box height: 100 cm. Then, the user clicks a “confirm” button, indicating that the input of the information of the SKU is completed, to hand over the inputted information to the terminal device for processing. Further referring to FIG. 3B, FIG. 3B is a schematic diagram of an application scenario of the method for processing information according to the present embodiment. In the figure, based on the information of the SKU inputted by the user, the above terminal device generates a packing code: 38b8c2c1093dd0fec383a9d9ac940515 (the packing code connected by the dotted arrow as shown in the figure). The terminal device stores the code of the SKU: 12345678, the number of SKUs: 6, the box length: 100 cm, the box width: 100 cm, the box height: 100 cm, and the packing code: 38b8c2c1093dd0fec383a9d9ac940515 in association; and then searches packing codes stored in association with the SKU code 12345678. Codes corresponding to 301 and 302 in the figure are stored in association with the code, and then the number of the packing code stored in association with the code is 2. Further referring to FIG. 3C, FIG. 3C is another schematic diagram of an application scenario of the method for processing information according to the present embodiment. In the figure, the terminal device deletes the packing code corresponding to 301.

The method provided by the above embodiments of the present disclosure automatically generates a packing code based on the information of a SKU, and determines a unique target packing code corresponding to identical SKU codes, thereby reducing the information redundancy, and improving the automation degree of information processing.

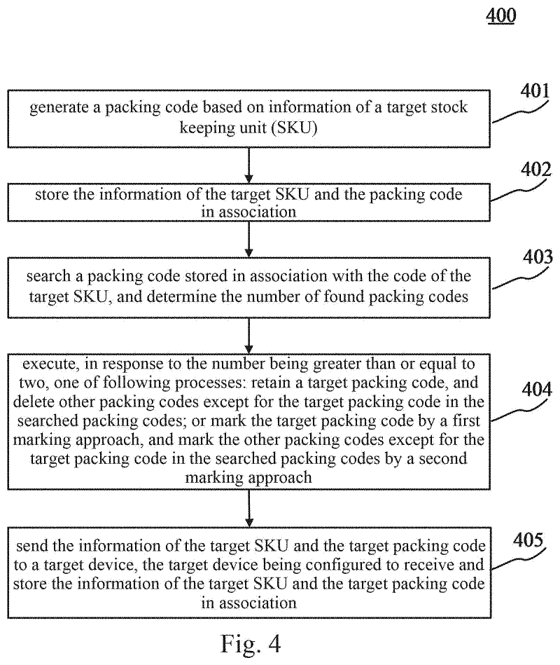

Further referring to FIG. 4, a process 400 of the method for processing information of another embodiment is shown. The process 400 of the method for processing information includes the following steps:

Step 401: generating a packing code based on information of a target stock keeping unit (SKU), a SKU being for measuring in and out of a stock.

In the present embodiment, an electronic device (e.g., the terminal shown in FIG. 1) on which the method for processing information runs may generate the packing code of the SKU based on the information of the SKU inputted by a user. The information of the target SKU includes a code of the target SKU, and the packing code is used for identifying size information of a box into which the target SKU is to be packed.

Step 402: storing the information of the target SKU and the packing code in association.

In the present embodiment, the electronic device (e.g., the terminal device shown in FIG. 1) stores the information of the SKU and the packing code generated based on the information of the SKU in association, based on the packing code obtained in step 401.

Step 403: finding packing codes stored in association with the code of the target SKU, and determining the number of found packing codes.

In the present embodiment, the electronic device on which the method for processing information runs may find out, based on the code of the SKU, all packing codes stored in association with the code of the SKU, and then determine the number of found packing codes stored in association with the code of the SKU.

Step 404: executing, in response to the number being greater than or equal to two, one of following processes: retaining a target packing code, and deleting other packing codes except for the target packing code in the found packing codes; or marking the target packing code by a first marking approach, and marking the other packing codes except for the target packing code in the found packing codes by a second marking approach.

In the present embodiment, if the number of found packing codes in step 403 is greater than or equal to two, then a target packing code is selected from the found packing codes, a storing or marking operation on the target packing code is executed, and a deleting operation on other found packing codes is correspondingly executed, or the other found packing codes are marked by a marking approach different from a marking approach of the target packing code, to select the target packing code or distinguish the target packing code from the other found packing codes.

Step 405: sending the information of the target SKU and the target packing code to a target device, the target device being configured to receive and store the information of the target SKU and the target packing code in association.

In the present embodiment, the electronic device on which the method for processing information runs may send the information of the target SKU and the target packing code to the target device, such that the target device receives and stores the information of the target SKU and the target packing code in association.

In an exemplary embodiment, at present, for example, there are a warehouse A and a warehouse B, and both of the two warehouses have a demand for packing the same wine, then two electronic devices (hereinafter referred to as device A and device B) on which the method for processing information runs may be used for offsite on-site information processing. Assuming that at present, the device A is used in the warehouse A for starting information processing firstly, and firstly determining the target packing code. In this case, the device A may send just processed information of the SKU and the target packing code to the device B, and then the device B receives and stores the information of the target SKU and the target packing code sent by the device A in association.

In some alternative implementations of the present embodiment, when receiving a request for storing the code of the SKU and the packing code in association, the electronic device, the method for processing information runs thereon, first stores the information of the SKU and the packing code in association, then find out all packing codes stored in association with the code of the SKU based on the code of the SKU, and then determine the number of found packing codes stored in association with the code of the SKU. Then, the number of found packing codes is determined. If the number of found packing codes is greater than or equal to two, then a target packing code is selected from the found packing codes, a storing or marking operation on the target packing code is executed, and a deleting operation on other found packing codes is correspondingly executed, or the other found packing codes are marked by a marking approach different from a marking approach of the target packing code, to retain the target packing code or distinguish the target packing code from the other found packing codes. It should be noted that the request may be sent by other electronic devices or inputted by the user.

In some alternative implementations of the present embodiment, after the executing one of the following processes, the method may further include: determining, in response to receiving a first request for finding information of a SKU corresponding to a code of the SKU, whether the code of the SKU included in the first request is stored; and finding and outputting, in response to determining the code of the SKU included in the first request being stored, the information of the SKU stored in association with a first packing code corresponding to the code of the SKU included in the first request, where the first packing code is the retained packing code or the packing code marked by the first marking approach.

It will be appreciated that the above alternative implementation may implement determining stored additional information of a SKU based on the code of the SKU. For example, assuming that a batch of wine newly arrives at a warehouse, a worker needs to pack the batch of wine. In order to prevent other workers from packing the same wine indifferent forms, the worker may input the code of the wine into the terminal device. If the same wine has been packed by other workers before the worker packing the wine, the terminal device has stored information of the wine and a packing code of the wine in association. In this case, additional information of the wine, such as the name, the number of bottles of the wine packed in a box, length, width, and height of the pacing box, and the packing code, may be displayed by inputting the code of the wine. The worker may pack the batch of wine based on the displayed information. The information of a SKU is found out based on the packing code of the SKU, and then the SKU is packed based on the found information, thus preventing a different personnel from packing the same SKU differently, and then facilitating information processing and management.

In some alternative implementations of the present embodiment, after the executing one of the following processes, the method may further include: determining, in response to receiving a second request for finding information of a SKU stored in association with a packing code, whether the packing code included in the second request is a first packing code, where the first packing code is the retained packing code or the packing code marked by the first marking approach; and finding and outputting, in response to determining the packing code included in the second request being the first packing code, information of the SKU stored in association with the packing code included in the second request.

As can be seen from FIG. 4, compared with the corresponding embodiment of FIG. 2, the process 400 of the method for processing information in the present embodiment highlights the sending the information of the target SKU and the target packing code to the target device. Accordingly, the scheme described in the present embodiment may implement offsite asynchronous information processing, thus achieving more flexible information collection.

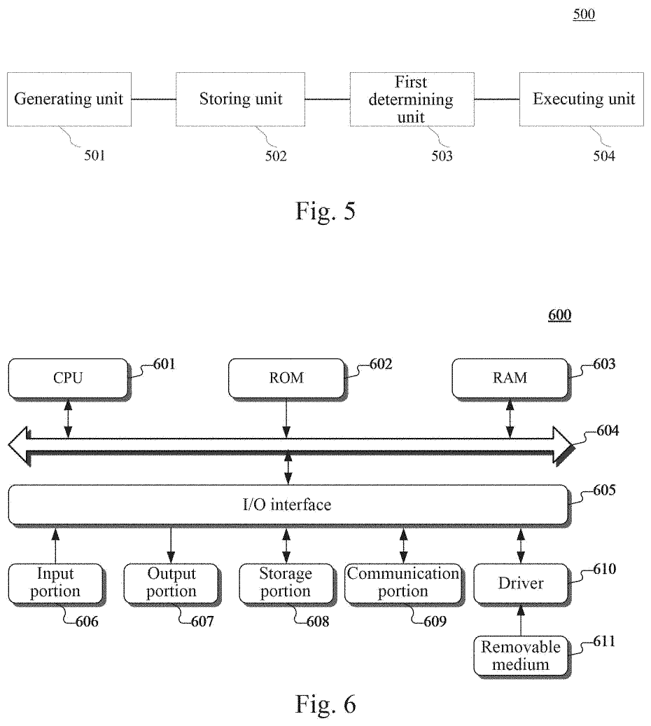

Further referring to FIG. 5, as an implementation of the method shown in the above figures, an embodiment of the present disclosure provides an apparatus for processing information. The embodiment of the apparatus corresponds to the embodiment of the method shown in FIG. 2. The apparatus may be specifically applied to various electronic devices.

As shown in FIG. 5, the apparatus 500 for processing information of the present embodiment includes: a generating unit 501, a storing unit 502, a first determining unit 503, and an executing unit 504. The generating unit 501 is configured to generate a packing code based on information of a target stock keeping unit (SKU), a SKU being for measuring in and out of a stock, the information of the target SKU including a code of the target SKU, the packing code being used for identifying size information of a box into which the target SKU is to be packed; the storing unit 502 is configured to store the information of the target SKU and the packing code in association; the first determining unit 503 is configured to find a packing code stored in association with the code of the target SKU, and determine a number of found packing codes; and the executing unit 504 is configured to execute, in response to determining the number being greater than or equal to two, one of the following processes: retaining a target packing code, and deleting other packing codes except for the target packing code in the found packing codes; or marking the target packing code by a first marking approach, and marking the other packing codes except for the target packing code in the found packing codes by a second marking approach.

In the present embodiment, the generating unit 501 of the apparatus 500 for processing information may generate the packing code of the SKU using a preset algorithm based on the information of the SKU inputted by a user, where the preset algorithm may be a message digest algorithm version 5, a secure hash algorithm, and a data encryption standard algorithm, or other encryption algorithms, or a combination of a plurality of algorithms, or multiple combinations of a given algorithm.

In the present embodiment, based on the packing code obtained by the generating unit 501, the storing unit 502 may store the information of the SKU and the packing code generated based on the information of the SKU in association.

In the present embodiment, the apparatus 500 for processing information may pre-store a plurality of pairs of the information of the SKU and the packing code generated based on the information of the SKU in association. Thus, the first determining unit 503 of the apparatus 500 for processing information may find out, based on a code of the SKU, all packing codes stored in association with the code of the SKU, and then determine the number of found packing codes stored in association with the code of the SKU.

In the present embodiment, in response to the number being greater than or equal to two, the executing unit 504 may execute one of the following processes: retaining a target packing code, and deleting other packing codes except for the target packing code in the found packing codes; or marking the target packing code by a first marking approach, and marking the other packing codes except for the target packing code in the found packing codes by a second marking approach.

In some alternative implementations of the present embodiment, the apparatus may further include: a sending unit configured to send the information of the target SKU and the target packing code to a target device, where the target device is configured to receive and store the information of the target SKU and the target packing code in association.

In some alternative implementations of the present embodiment, the apparatus may further include: a second determining unit configured to determine, in response to receiving a first request for finding information of a SKU corresponding to a code of the SKU, whether the code of the SKU included in the first request is stored; and a first outputting unit configured to find and output, in response to determining the code of the SKU included in the first request being stored, information of the SKU stored in association with a first packing code corresponding to the code of the SKU included in the first request, where the first packing code is the retained packing code or the packing code marked by the first marking approach.

In some alternative implementations of the present embodiment, the apparatus may further include: a third determining unit configured to determine, in response to receiving a second request for finding information of a SKU stored in association with a packing code, whether the packing code included in the second request is a first packing code, where the first packing code is the retained packing code or the packing code marked by the first marking approach; and a second outputting unit configured to find and output, in response to determining the packing code included in the second request being the first packing code, the information of the SKU stored in association with the packing code included in the second request.

In some alternative implementations of the present embodiment, the information of the target SKU may further include the number of SKUs containable in the box into which the target SKU is to be packed; and the generating unit may further include: a first generating module configured to generate a measurement unit code based on the code of the target SKU, and the number of SKUs containable in the box into which the target SKU is to be packed, where the measurement unit code is used for identifying a packing approach of the target SKU; a first storing module configured to store the measurement unit code, in response to determining there being no other measurement unit code identical to the measurement unit code; a second generating module configured to generate the packing code based on the measurement unit code and size information of the box into which the target SKU is packed; and a second storing module configured to store the packing code, in response to determining there being no other packing code identical to the packing code.

In some alternative implementations of the present embodiment, the target packing code may include: a first found packing code or a randomly selected packing code.

In some alternative implementations of the present embodiment, the generating a packing code based on information of a target stock keeping unit (SKU), a SKU being for measuring in and out of a stock, may include: processing the information of the target SKU using the message digest algorithm version 5 or the secure hash algorithm, to generate the packing code.

In some alternative implementations of the present embodiment, the apparatus may further include: a receiving unit configured to, when receiving a request for storing the code of the SKU and the packing code in association, first store the information of the SKU and the packing code in association, then find out all packing codes stored in association with the code of the SKU based on the code of the SKU, and then determine the number of found packing codes stored in association with the code of the SKU. Then, the number of found packing codes is determined. If the number of found packing codes is greater than or equal to two, then the target packing code is selected from the found packing codes, a storing or marking operation on the target packing code is executed, and a deleting operation on other found packing codes is correspondingly executed, or the other found packing codes are marked by a marking approach different from a marking approach of the target packing code, to retain the target packing code or distinguish the target packing code from the other found packing codes.

Referring to FIG. 6 below, a schematic structural diagram of a computer system 600 adapted to implement a terminal device of the embodiments of the present disclosure is shown. The terminal device shown in FIG. 6 is merely an example, and should not impose any limitation on the functions and scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium X11, and the installation thereof on the storage portion X08 as needed.

In particular, according to embodiments of the present disclosure, the process described above with reference to the flow chart may be implemented in a computer software program. For example, an embodiment of the present disclosure includes a computer program product, which comprises a computer program that is hosted in a machine-readable medium. The computer program comprises program codes for executing the method as illustrated in the flow chart. In such an embodiment, the computer program may be downloaded and installed from a network via the communication portion 609, and/or may be installed from the removealbe medium 611. The computer program, when executed by the central processing unit (CPU) 601, implements the above mentioned functionalities as defined by the methods of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In some embodiments of the present disclosure, the computer readable storage medium may be any tangible medium containing or storing programs which can be used by a command execution system, apparatus or element or incorporated thereto. In some embodiments of the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present disclosure may be implemented by means of software or hardware. The described units or modules may also be provided in a processor, for example, described as: a processor, comprising a generating unit, a storing unit, a first determining unit an an executing unit, where the names of these units or modules do not in some cases constitute a limitation to such units or modules themselves. For example, the generating unit may also be described as “a unit for generating a packing code.”

In another aspect, some embodiments of the present disclosure further provide a computer-readable storage medium. The computer-readable storage medium may be included in the apparatus in the above described embodiments, or a stand-alone medium not assembled into the apparatus. The computer-readable storage medium stores one or more programs. The one or more programs, when executed by a device, cause the device to: generating a packing code based on information of a target stock keeping unit (SKU), a SKU being for measuring in and out of a stock, the information of the target SKU comprising a code of the target SKU, the packing code being used for identifying size information of a box into which the target SKU is to be packed; storing the information of the target SKU and the packing code in association; finding a packing code stored in association with the code of the target SKU, and determining a number of found packing codes; and executing, in response to the number being greater than or equal to two, one of following processes: retaining a target packing code, and deleting other packing codes except for the target packing code in the found packing codes; or marking the target packing code by a first marking approach, and marking the other packing codes except for the target packing code in the found packing codes by a second marking approach.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A method for processing information, comprising:
generating a packing code based on information of a target stock keeping unit (SKU), a SKU being for measuring in and out of a stock, the information of the target SKU comprising a code of the target SKU, the packing code being used for identifying size information of a box into which the target SKU is to be packed;
storing the information of the target SKU and the packing code in association;
finding a packing code stored in association with the code of the target SKU, and determining a number of found packing codes; and
executing, in response to the number being greater than or equal to two, one of following processes:
retaining a target packing code, and deleting other packing codes except for the target packing code in the found packing codes; or
marking the target packing code by a first marking approach, and marking the other packing codes except for the target packing code in the found packing codes by a second marking approach.

2. The method according to claim 1, wherein after the executing one of following processes, the method further comprises:
sending the information of the target SKU and the target packing code to a target device, wherein the target device is configured to receive and store the information of the target SKU and the target packing code in association.

3. The method according to claim 1, wherein after the executing one of following processes, the method further comprises:
determining, in response to receiving a first request for finding information of a SKU corresponding to a code of the SKU, whether the code of the SKU included in the first request is stored; and
finding and outputting, in response to determining the code of the SKU included in the first request being stored, information of the SKU stored in association with a first packing code corresponding to the code of the SKU included in the first request, wherein the first packing code is the retained packing code or the packing code marked by the first marking approach.

4. The method according to claim 1, wherein after the executing one of following processes, the method further comprises:
determining, in response to receiving a second request for finding information of a SKU stored in association with a packing code, whether the packing code included in the second request is a first packing code, wherein the first packing code is the retained packing code or the packing code marked by the first marking approach; and
finding and outputting, in response to determining the packing code included in the second request being the first packing code, information of the SKU stored in association with the packing code included in the second request.

5. The method according to claim 1, wherein the target packing code is a first found packing code or a randomly selected packing code.

6. The method according to claim 1, wherein the generating a packing code based on information of a target stock keeping unit (SKU), a SKU being for measuring in and out of a stock, comprises:
processing the information of the target SKU using a message digest algorithm version 5 or a secure hash algorithm, to generate the packing code.

7. The method according to claim 1, wherein the information of the target SKU further comprises a number of SKUs containable in the box into which the target SKU is to be packed; and
wherein the generating a packing code based on information of a target stock keeping unit (SKU), a SKU being for measuring in and out of a stock, comprises:
generating a measurement unit code based on the code of the target SKU, and the number of SKUs containable in the box into which the target SKU is to be packed, wherein the measurement unit code is used for identifying a packing approach of the target SKU;
storing the measurement unit code, in response to determining there being no other measurement unit code identical to the measurement unit code;
generating the packing code based on the measurement unit code and the size information of the box into which the target SKU is to be packed; and
storing the packing code, in response to determining there being no other packing code identical to the packing code.

8. An apparatus for processing information, comprising:
at least one processor; and
a memory storing instructions, the instructions when executed by the at least one processor, cause the at least one processor to perform operations, the operations comprising:
generating a packing code based on information of a target stock keeping unit (SKU), a SKU being for measuring in and out of a stock, the information of the target SKU comprising a code of the target SKU, the packing code being used for identifying size information of a box into which the target SKU is to be packed;
a storing unit configured to storing the information of the target SKU and the packing code in association;
finding a packing code stored in association with the code of the target SKU, and determining a number of found packing codes; and
executing, in response to determining the number being greater than or equal to two, one of following processes:
retaining a target packing code, and deleting other packing codes except for the target packing code in the found packing codes; or
marking the target packing code by a first marking approach, and marking the other packing codes except for the target packing code in the found packing codes by a second marking approach.

9. The apparatus according to claim 8, wherein after the executing one of following processes, the operations further comprise:
sending the information of the target SKU and the target packing code to a target device, wherein the target device is configured to receive and store the information of the target SKU and the target packing code in association.

10. The apparatus according to claim 8, wherein after the executing one of following processes, the operations further comprise:
determining, in response to receiving a first request for finding information of a SKU corresponding to a code of the SKU, whether the code of the SKU included in the first request is stored; and
finding and outputting, in response to determining the code of the SKU included in the first request being stored, information of the SKU stored in association with a first packing code corresponding to the code of the SKU included in the first request, wherein the first packing code is the retained packing code or the packing code marked by the first marking approach.

11. The apparatus according to claim 8, wherein after the executing one of following processes, the operations further comprise:
determining, in response to receiving a second request for finding information of a SKU stored in association with a packing code, whether the packing code included in the second request is a first packing code, wherein the first packing code is the retained packing code or the packing code marked by the first marking approach; and
finding and outputting, in response to determining the packing code included in the second request being the first packing code, information of the SKU stored in association with the packing code included in the second request.

12. The apparatus according to claim 8, wherein the information of the target SKU further comprises a number of SKUs containable in the box into which the target SKU is to be packed; and
wherein the generating a packing code based on information of a target stock keeping unit (SKU) further comprises:
generating a measurement unit code based on the code of the target SKU, and the number of SKUs containable in the box into which the target SKU is to be packed, wherein the measurement unit code is used for identifying a packing approach of the target SKU;
storing the measurement unit code, in response to determining there being no other measurement unit code identical to the measurement unit code;
generating the packing code based on the measurement unit code and size information of the box into which the target SKU is packed; and
storing the packing code, in response to determining there being no other packing code identical to the packing code.

13. (canceled)

14. A non-transitory computer readable storage medium, storing a computer program thereon, wherein the program, when executed by a processor, causes the processor to implement operations, the operations comprising:
generating a packing code based on information of a target stock keeping unit (SKU), a SKU being for measuring in and out of a stock, the information of the target SKU comprising a code of the target SKU, the packing code being used for identifying size information of a box into which the target SKU is to be packed;
storing the information of the target SKU and the packing code in association;
finding a packing code stored in association with the code of the target SKU, and determining a number of found packing codes; and
executing, in response to the number being greater than or equal to two, one of following processes:
retaining a target packing code, and deleting other packing codes except for the target packing code in the found packing codes; or
marking the target packing code by a first marking approach, and marking the other packing codes except for the target packing code in the found packing codes by a second marking approach.

15. The medium according to claim 14, wherein after the executing one of following processes, the operations further comprise:
sending the information of the target SKU and the target packing code to a target device, wherein the target device is configured to receive and store the information of the target SKU and the target packing code in association.

16. The medium according to claim 14, wherein after the executing one of following processes, the operations further comprise:
determining, in response to receiving a first request for finding information of a SKU corresponding to a code of the SKU, whether the code of the SKU included in the first request is stored; and
finding and outputting, in response to determining the code of the SKU included in the first request being stored, information of the SKU stored in association with a first packing code corresponding to the code of the SKU included in the first request, wherein the first packing code is the retained packing code or the packing code marked by the first marking approach.

17. The medium according to claim 14, wherein after the executing one of following processes, the operations further comprise:
determining, in response to receiving a second request for finding information of a SKU stored in association with a packing code, whether the packing code included in the second request is a first packing code, wherein the first packing code is the retained packing code or the packing code marked by the first marking approach; and
finding and outputting, in response to determining the packing code included in the second request being the first packing code, information of the SKU stored in association with the packing code included in the second request.

18. The medium according to claim 14, wherein the information of the target SKU further comprises a number of SKUs containable in the box into which the target SKU is to be packed; and
wherein the generating a packing code based on information of a target stock keeping unit (SKU), a SKU being for measuring in and out of a stock, comprises:
generating a measurement unit code based on the code of the target SKU, and the number of SKUs containable in the box into which the target SKU is to be packed, wherein the measurement unit code is used for identifying a packing approach of the target SKU;
storing the measurement unit code, in response to determining there being no other measurement unit code identical to the measurement unit code;
generating the packing code based on the measurement unit code and the size information of the box into which the target SKU is to be packed; and
storing the packing code, in response to determining there being no other packing code identical to the packing code.

19. The apparatus according to claim 8, wherein the target packing code is a first found packing code or a randomly selected packing code.

20. The apparatus according to claim 8, wherein the generating a packing code based on information of a target stock keeping unit (SKU), a SKU being for measuring in and out of a stock, comprises:
processing the information of the target SKU using a message digest algorithm version 5 or a secure hash algorithm, to generate the packing code.
